(19) United States
(12) Patent Application Publication
(10) Pub. No.: US 2011/0164185 A1
(43) Pub. Date: Jul. 7, 2011

(54) APPARATUS AND METHOD FOR PROCESSING IMAGE DATA

(75) Inventors: Dong-Ryeol PARK, Gyeonggi-do (KR); Yeon-Ho Kim, Gyeonggi-do (KR); Ki-Wan Choi, Gyeonggi-do (KR)

(73) Assignee: SAMSUNG ELECTRONICS CO., LTD., Suwon-si (KR)

(21) Appl. No.: 12/961,144

(22) Filed: Dec. 6, 2010

(30) Foreign Application Priority Data
Jan. 4, 2010 (KR) 10-2010-0000238

(51) Int. Cl. H04N 9/74

(52) U.S. Cl. 348/586; 348/E09.055

(57) ABSTRACT

Provided are an image processing apparatus and method for extracting foreground data from among image data. The image processing apparatus generates background data and compares the background data with received data to extract a foreground. The foreground may be extracted using information regarding distances from an image acquiring unit to objects included in received data.

### CROSS-REFERENCE TO RELATED APPLICATIONS

This application claims the benefit under 35 U.S.C. §119(a) of a Korean Patent Application No. 10-2010-0000238, filed on Jan. 4, 2010, the entire disclosure of which is incorporated herein by reference for all purposes.

### BACKGROUND

1. Field

The following description relates to an image processing apparatus and method for extracting a foreground.

2. Description of the Related Art

A technology of segmenting an image into a foreground and a background has been applied in various systems, for example, monitoring systems, interfaces for intercommunications between computers and humans, video signal analyzers and the like. The foreground is a region in which variations in the image occur and the background refers to a region in which variations in the image do not occur. For example, the background may correspond to a region that does not exhibit motion, such as walls, a ceiling, a floor or the like, and the foreground may correspond to a region that can exhibit motion, such as people, chairs, objects or the like.

The segmentation technology has been increasingly utilized for various technical fields, and recently, studies on a technology for extracting exact foregrounds from complex images are actively being conducted.

### SUMMARY

The following description relates to an image processing apparatus and method for extracting foreground data from image data.

In one general aspect, there is provided an image processing apparatus including: a background generator to generate background data from first image data composed of one or more image frames, using information regarding durations for which background areas of the first image data are generated where data variations between the image frames are below a predetermined threshold value; a distance calculator to calculate first distances from an image acquiring unit for acquiring the image frames to objects included in the first background data and second distances from the image acquiring unit to objects included in second image data received by the image acquiring unit after a predetermined time elapses; and a foreground generator to generate first foreground data based on the background data and the second image data, to generate second foreground data based on the first distances and the second distances, and to generate third foreground data based on the first foreground data and the second foreground data.

The foreground generator may compare the first distances with the second distances, to generate image data from the second image data as the second foreground data, corresponding to objects that are determined to be positioned nearer to the image acquiring unit than objects corresponding to the background data.

The foreground generator may generate, as the third foreground data, image data which denotes areas in which an area corresponding to the first foreground data overlaps an area corresponding to the second foreground data.

The background generator may generate the background data which denotes the background areas of the first image data, when the durations of the background areas are equal to or longer than a predetermined threshold value.

The foreground generator may compare the background data with the second image data in units of blocks using Normalized Cross Correlation (NCC).

In another general aspect, there is provided an image processing apparatus including: a background generator to generate short-term background data from first image data composed of one or more first image frames, using information regarding durations for which first background areas of the first image data are generated where data variations between the first image frames are below a first threshold value, and to generate long-term background data from second image data composed of one or more second image frames received after a predetermined time elapses, using information regarding durations for which second background areas of the second image data are generated where data variations between the second image frames are below a second threshold value; a distance calculator to calculate first distances from an image acquiring unit to objects included in the short-term background data and second distances from the image acquiring unit to objects included in the second image data; and a foreground generator to generate first foreground data based on the short-term background data and the second image data, to generate second foreground data based on the first distances and the second distances, to generate third foreground data based on the first foreground data and the second foreground data and to generate fourth foreground data by comparing the third foreground data with the long-term background data.

The foreground generator may compare the first distances with the second distances, to generate, as the second foreground data, image data from the second image data, the image data denoting objects that are determined to be positioned nearer to the image acquiring unit than objects corresponding to the short-term background data.

The background generator may generate the first background areas as the short-term background data when the durations of the first background areas are equal to or longer than the first threshold value, and generate the second background areas as the long-term background data when the durations of the second background areas are equal to or longer than the second threshold value.

In another general aspect, there is provided an image processing method including: generating short-term background data from first image data composed of one or more first image frames, using information regarding durations for which first background areas of the first image data are generated where data variations between the first image frames are below a first threshold value; calculating first distances from an image acquiring unit for acquiring the image frames to objects included in the short-term background data and second distances from the image acquiring unit to objects included in the second image data; and comparing the short-term background data with the second image data to generate first foreground data; comparing the first distances with the second distances to generate second foreground data; and generating third foreground data based on the first foreground data and the second foreground data.

The image processing method may include: generating long-term background data from second image data composed of one or more second image frames received after a predetermined time elapses, using information regarding durations for which second background areas of the second image data are generated where data variations between the second image frames are below a second threshold value; and comparing the long-term background data with the third foreground data to generate fourth foreground data.

Other features and aspects will be apparent from the following detailed description, the drawings, and the claims.

### BRIEF DESCRIPTION OF THE DRAWINGS

FIG. 1 is a diagram illustrating an example of an image processing apparatus.

FIG. 2 is a view for explaining an example of a background data generating method.

FIG. 3 is a flowchart illustrating an example of an image processing method.

FIG. 4 is a flowchart illustrating operation 205 of generating a short-term background in the image processing method of FIG. 3.

FIG. 5 is a flowchart illustrating operation 235 of generating a long-term background in the image processing method of FIG. 3.

FIGS. 6A, 6B and 6C illustrate exemplary images for explaining a procedure in which an example of the image processing method is performed.

FIGS. 7A, 7B and 7C illustrate exemplary images for explaining a procedure in which another example of the image processing method is performed.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

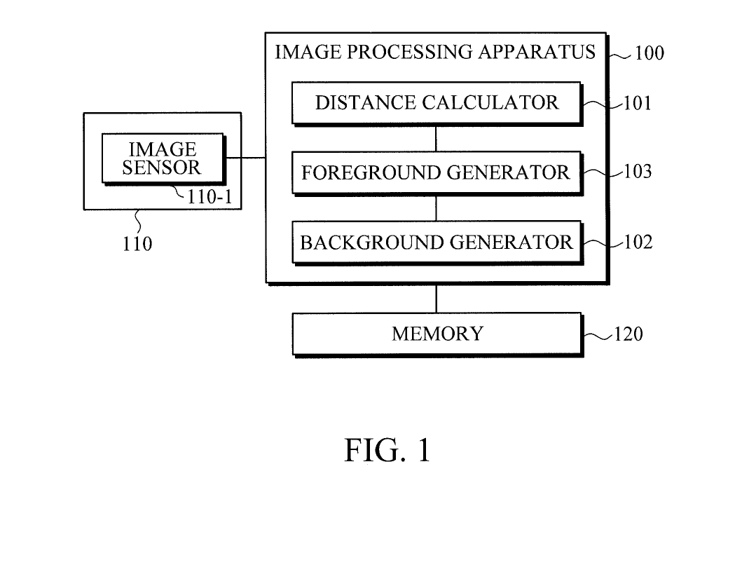

FIG. 1 is a diagram illustrating an example of an image processing apparatus 100.

Referring to FIG. 1, the image processing apparatus 100 may include a distance calculator 101, a foreground generator 103, a background generator 102, a camera 110 and a memory 120. The camera 110 and memory 120 may be installed in the image processing apparatus 100 (which may be a computer) or provided as separate external devices.

The camera 110 may process image frames (hereinafter, referred to as “image data”), such as still images or moving images, acquired by an image sensor 110-1 installed therein. The processed imaged data may be displayed on a display such as a monitor or the like. The image sensor 110-1 installed in the camera 110 may be a Charge Coupled Device (CCD), a Complementary Metal Oxide Semiconductor (CMOS), a Contact Image sensor (CIS) or the like. The camera 110 is a kind of image acquiring unit capable of acquiring image frames.

One method of estimating distances from a camera to objects included in an image, is a stereo-based distance estimation, wherein the objects may include persons and objects, for example, a desk, a chair, a ceiling or the like. It is also possible for a plurality of cameras to be provided. When a single camera is provided, the image processing apparatus 100 may obtain the same effect as when two cameras are utilized by photographing a scene two times or more while rotating the camera about an axis of rotation. Meanwhile, when two cameras are utilized, the image processing apparatus 100 may receive image data from the two cameras. The image processing apparatus 100 may use triangulation to estimate distances for received image data.

As another example, the image processing apparatus 100 may calculate distances from the camera 110 to objects using a 3-dimensional distance sensor (not shown). The 3-dimensional distance sensor may be an infrared (IR) sensor or an ultrasonic sensor. That is, the image processing apparatus 100 may calculate distances from the camera 110 to objects based on signals sensed by the 3-dimensional distance sensor.

The distance calculator 101 may estimate the distances from the camera 110 to the objects based on images received by the camera 110. That is, the estimated distances may be displayed as numerical values or images on a display (not shown). Through viewing the displayed values, a user may be aware of the distances from the camera 110 to the objects included in the image. Alternatively, the distance calculator 101 may calculate the distances from the camera 101 to the objects based on signals sensed by the 3-dimensional distance sensor.

The display may be a LCD, a TFT LCD, an OLED, a flexible display or a 3D display (not shown).

The background generator 102 may generate background data based on image data including a plurality of image frames.

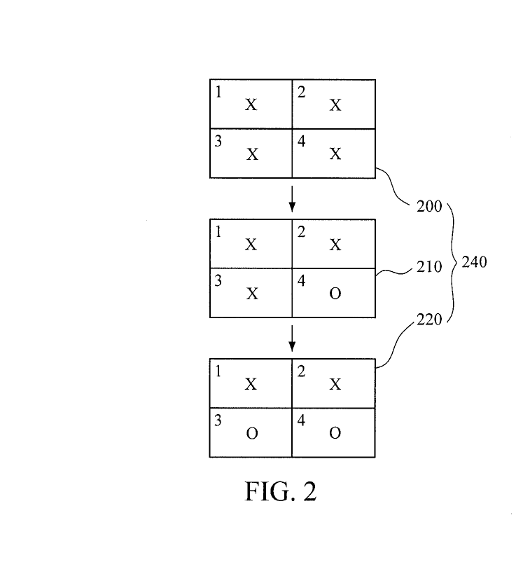

FIG. 2 is a view for explaining an example of a background data generating method. Referring to FIG. 2, the background generator 102 may generate background data from first image data 240 composed of image frames 200, 210 and 220, using information regarding durations for which background areas of the first image data 240 are generated. Data variations between the image frames 200, 210 and 220 are below a predetermined threshold value. The background areas may be processed in units of pixels or in units of blocks.

For example, when background areas are processed in units of blocks, the background generator 102 may divide each of the image frames 200, 210 and 220 into four blocks 1, 2, 3 and 4 and compare the blocks 1, 2, 3 and 4 of each image frame with the blocks 1, 2, 3 and 4 of the next image frame, respectively, to determine durations of blocks which have data variations below a predetermined threshold value. The predetermined threshold value may be set to an appropriate value such that the background areas may be portions with little or no data variations. Referring to FIG. 2, blocks with data variations below the predetermined threshold value are denoted by “X” and blocks with data variations equal to or greater than the predetermined threshold value are denoted by “O”. For example, when an image frame is produced in a unit of one second, durations of the blocks 1 and 2 that are determined as background areas may be 3 seconds, a duration of the block 3 that is determined as a background area may be 2 seconds and a duration of the block 4 that is determined as a background area may be 1 second.

The background generator 102 may determine certain areas as short-term background data when the durations of the areas are longer than a short-term reference time (also referred to as a first threshold value). For example, if the first threshold value is one second, the background generator 102 may determine the areas corresponding to the blocks 1, 2 and 3 as short-term background data.

The background generator 102 may determine, when the durations of the areas are longer than a long-term reference time (also referred to as a second threshold value), the areas as long-term background data. For example, if the second threshold value is 2 seconds, the background generator 102 may determine the areas corresponding to the blocks 1 and 2 as long-term background data. Here, the second threshold value is set to be greater than the first threshold value. The first threshold value may be set to a relatively short time duration, for example, from 1 to 30 seconds, and the second threshold value may be set to a relatively long time duration, for example, from 50 seconds to 3 minutes.

The foreground generator 103 may generate first foreground data based on the short-term background data and second image data composed of one or more image frames received after the short-term background data has been generated.

For example, the foreground generator 103 may calculate difference values between the short-term background data and the second image data in units of pixels. Here, the difference values may be differences in R, G and B color values between the short-term background data and the second image data, and the R, G and B color values may be mean values of R, G and B values. Then, the foreground generator 103 may extract areas where the calculated difference values are greater than a predetermined reference value (that is, a predetermined threshold value) as first foreground data, wherein the predetermined reference value may be set to an appropriate value by a manufacturer. It is also understood that the predetermined reference value may be set by a user.

As another example, the foreground generator 103 may calculate difference values between the short-term background data and the second image data in units of blocks, to generate first foreground data based on the difference values. At this time, the foreground generator 103 may generate the first foreground data using Normalized Cross Correlation (NCC). That is, the foreground generator 103 may calculate cross correlation coefficients between the short-term background data and the second image data and normalize the cross correlation coefficients. Then, the foreground generator 103 may generate first foreground data based on the normalized cross correlation coefficients. When any of the normalized cross correlation coefficients has a great value it means that the corresponding area has little variation, and when any of the normalized cross correlation coefficients has a small value it means that the corresponding area has a meaningful variation. For example, the foreground generator 103 may extract areas where cross correlation coefficients are below a predetermined threshold value, as first foreground data.

The foreground generator 103 may generate second foreground data based on the distance values calculated by the distance calculator 101. In detail, the distance calculator 101 may calculate first distances from the camera 110 to objects included in the short-term background data and second distances from the camera 110 to objects included in the second image data. The foreground generator 103 may compare the first distances with the second distances, respectively, to extract, as second foreground data, objects of the second image data that are determined to be positioned nearer to the camera 110 than the objects of the short-term background data. Then, the foreground generator 103 may generate third foreground data which denotes areas in which areas corresponding to the first foreground data overlap areas corresponding to the second foreground data.

The foreground generator 103 may compare the third foreground data with long-term background data to generate fourth foreground data. At this time, the foreground generator 103 may generate fourth foreground data by comparing the third foreground data with the long-term background data in units of pixels or in units of blocks.

As such, the image processing apparatus 100 may extract foreground data precisely by extracting a foreground based on distance.

Furthermore, since the image processing apparatus 100 generates foreground data through block-based comparison, the image processing apparatus 100 can generate foreground data in a short time with less influence by noise such as changes in lighting.

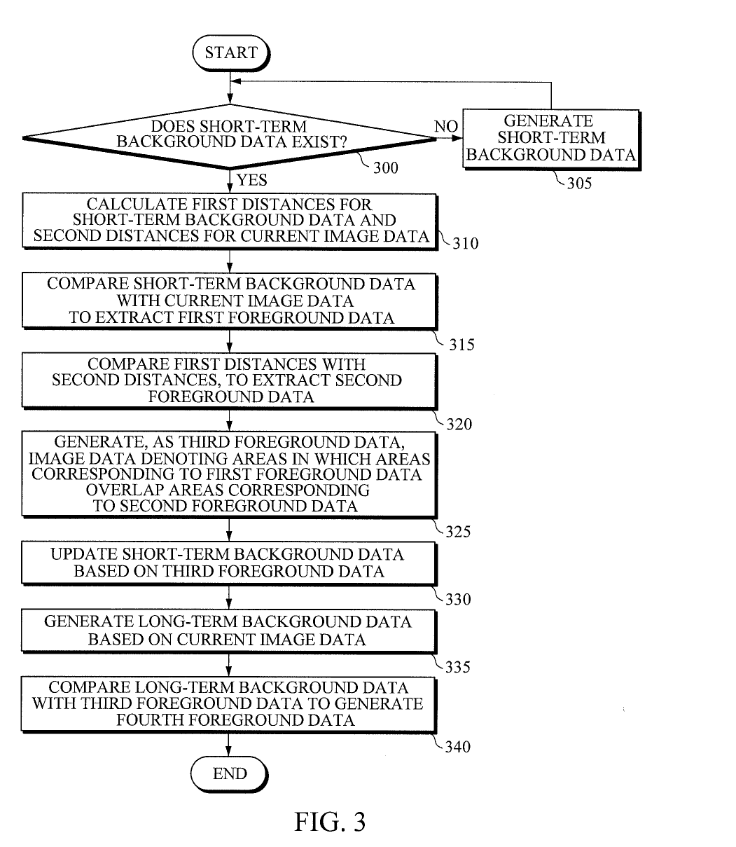

FIG. 3 is a flowchart illustrating an example of an image processing method.

Referring to FIGS. 1 and 3, first, the image processing apparatus 100 determines whether short-term background data exists (300). If no short-term background data is found, the background generator 102 generates short-term background data using received image data (that is, first image data) (305). Details of a method of generating short-term background data will be given with reference to FIG. 3.

Meanwhile, if short-term background data is found, the distance calculator 101 calculates first distances from an image acquiring device (for example, a camera) to objects included in the short-term background data and second distances from the camera to objects included in current image data (also referred to as second image data) (310). Here, the second image data is data received after the short-term background data has been generated.

Then, the foreground generator 103 compares the short-term background data with the second image data to generate first foreground data (315). While or after generating the first foreground data, the foreground generator 103 compares the first distances with the second distances to generate second foreground data (320). Then, the foreground generator 103 generates third foreground data which denotes areas in which areas corresponding to the first foreground data overlap areas corresponding to the second foreground data (325). As such, by generating as third foreground data only areas included in both the first foreground data and second foreground data, moving objects may be prevented from being registered as a background when their motions stop momentarily.

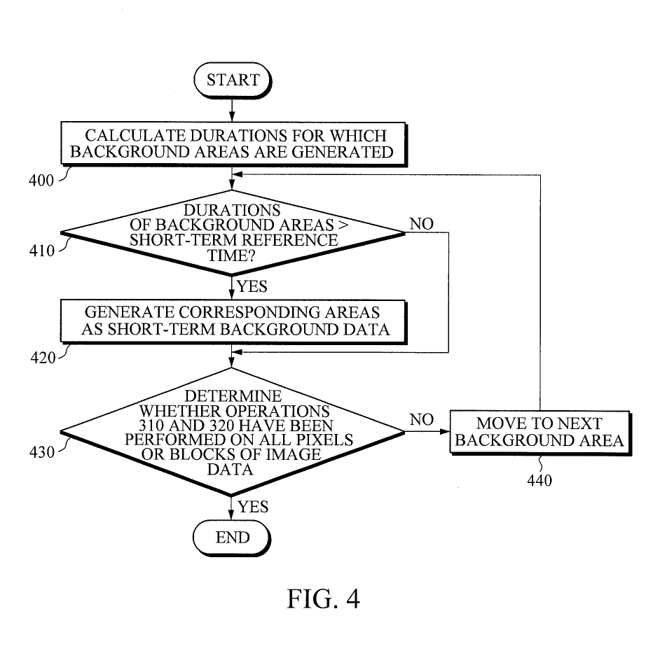

The background generator 102 updates the short-term background data based on the third foreground data (330). For example, the background generator 102 may register areas excluding the areas corresponding to the third foreground data from the second image data, as short-term background data. The background generator 102 generates long-term background data based on the second image data (335). Details of a method of generating long-term background data will be given with reference to FIG. 4. By comparing the long-term background data with the second image data, motionless areas among areas extracted as the third foreground data can be prevented from being extracted as foreground data.

The foreground generator 103 compares the long-term background data with the third foreground data to generate fourth foreground data (340). The fourth foreground data may be output through a display (not shown).

It will be apparent by those skilled in the art that the image processing method described above is only exemplary and its operations can be performed in a different order.

As described above, the image processing apparatus 100 can extract background data precisely by extracting a foreground based on distance.

FIG. 4 is a flowchart illustrating operation 305 of generating a short-term background in the image processing method of FIG. 3.

The background generator 102 calculates durations for which areas of current image data (second image data) are maintained without meaningful data variations (400). The durations for the second image data may be calculated in units of pixels or blocks. The background generator 102 may determine which areas of the second image data have durations that are longer than a predetermined short-term reference time (that is, a predetermined threshold value) (410). If it is determined that a duration of a certain area is longer than the predetermined short-term reference time, the background generator 102 generates the corresponding area as short-term background data (420). For example, when a duration of a certain area is 10 seconds and the predetermined short-term reference time is 5 seconds, the background generator 102 generates the corresponding area as short-term background data.

On the other hand, when it is determined that a duration of a certain area is equal to or shorter than the predetermined short-term reference time or after a certain area has been generated as short-term background data, the background generator 102 determines whether the operations 410 and 420 have been performed on all pixels or blocks of the second image data (430). If the operations 410 and 420 on all the pixels or blocks of the second image data are not complete, the background generator 102 receives a next predetermined range (that is, a next area) of the second image data (440) and returns to the operation 410 to calculate a duration for the next area and determine whether the duration is longer than the predetermined short-term reference time.

Meanwhile, when it is determined that the operations 410 and 420 on all the pixels or blocks of the second image data have already been completed, the background generator 102 terminates the process, thereby completing generation of short-term background data.

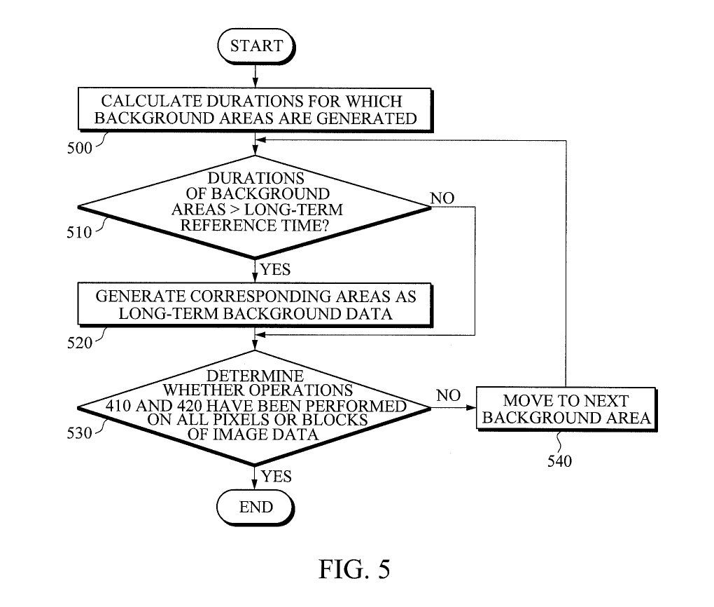

FIG. 5 is a flowchart illustrating operation 435 of generating a long-term background in the image processing method of FIG. 3.

The background generator 102 calculates durations for which areas of the current image data (that is, second image data) are maintained without meaningful data variations (500). The durations for the second image data may be calculated in units of pixels or blocks. Then, the background generator 102 determines whether a duration for an area is longer than a predetermined long-term reference time (that is, a predetermined threshold value) (510). The predetermined long-term reference time is set to be longer than the predetermined short-term reference time. If the duration for the area is longer than the predetermined long-term reference time, the background generator 102 generates long-term background data (520) corresponding to the area. For example, if the duration for the area is 60 seconds and the long-term reference time is 50 seconds, the background generator 102 generates long-term background data corresponding to the area. Then, the background generator 102 determines whether the operations 510 and 520 have been performed on all pixels or blocks of the second image data (530). If the operations 510 and 520 on all the pixels or blocks of the second image data are not complete, the background generator 102 receives a next area of the second image data (440) and returns to the operation 510 to calculate a duration for the next area and determine whether the duration is longer than the predetermined long-term reference time.

Meanwhile, when it is determined that the operations 510 and 520 on all the pixels or blocks of the second image data have already been completed, the background generator 102 terminates the process, thereby completing generation of long-term background data.

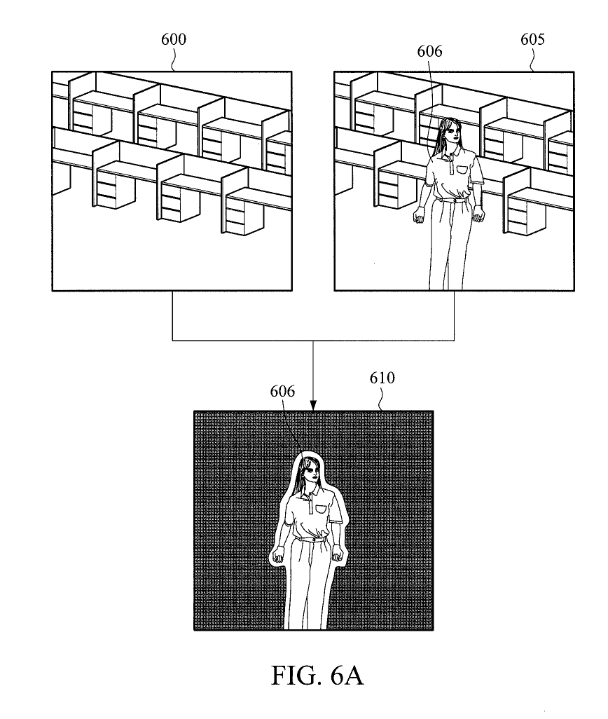

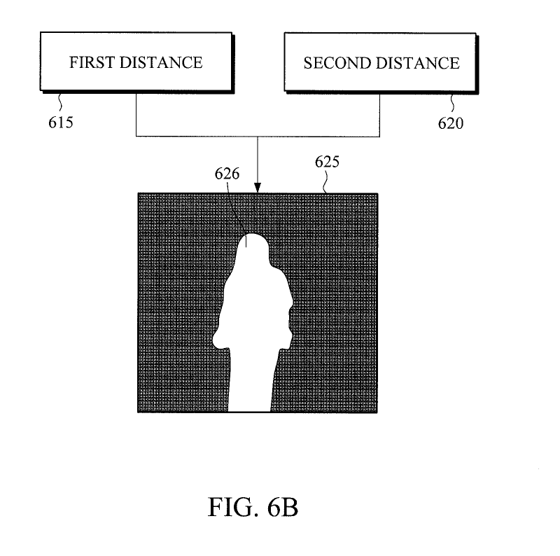

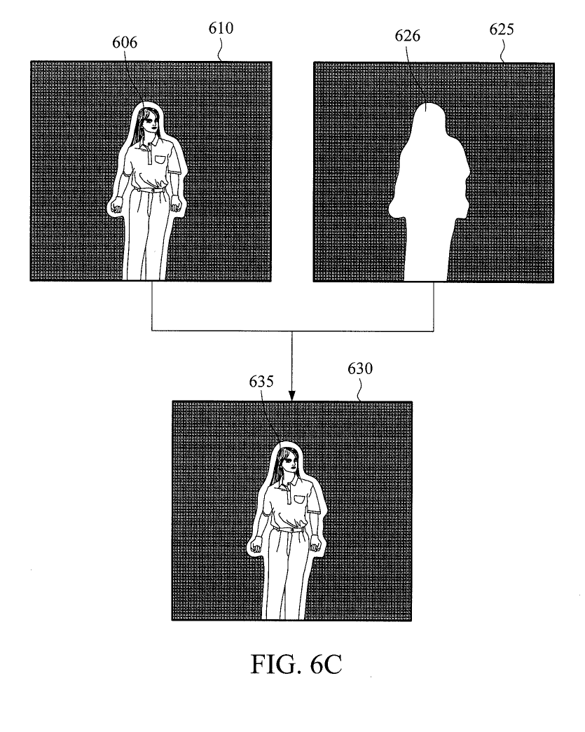

FIGS. 6A, 6B and 6C illustrate exemplary images for explaining a procedure in which the image processing method of FIG. 3 is performed.

FIG. 6A illustrate images for explaining a process in which the foreground generator 103 (see FIG. 1) compares short-term background data 600 with second image data 605 to generate first foreground data 610. Referring to FIG. 6A, the background generator 102 generates the short-term background data 600 based on received image data (referred to as first image data) and then compares the short-term background data 600 with the second image data 605. The second image data 605 may be an image including a moving object (for example, a moving person) 606. The foreground generator 103 may generate the first foreground data 610 including only the moving person 506 by comparing the short-term background data 600 with the second image data 605.

FIG. 6B illustrates images for explaining a process in which the foreground generator 103 compares a first distance 615 from the camera 110 (see FIG. 1) to an object included in short-term background data with a second distance 620 from the camera 110 to an object included in current image data (referred to as second foreground data) to generate second foreground data 625. The first and second distances 615 and 620 may be used as numerical values or image data by the distance calculator 101 (see FIG. 1). The foreground generator 103 extracts second foreground data 625 using the first and second distance 615 and 620. For example, the foreground generator 103 may generate, as the second foreground data 625, an area 626 of the second image data that is determined to be positioned nearer to the camera 110 than an area corresponding to the short-term background data. That is, the area 626 is determined to be an estimated foreground area.

FIG. 6C illustrates images for explaining a process in which the foreground generator 103 generates third foreground data 630 which denotes an area in which an area corresponding to the first foreground data 610 overlaps an area corresponding to the second foreground data 625. Referring to FIG. 6C, the foreground generator 103 generates the third foreground data 630 which denotes an area 635 included in common in the first foreground data 610 including the moving person 606 and the second foreground data 625 including the area 626. That is, the foreground generator 103 generates the third foreground data 630 which denotes an area where the moving person 606 overlaps the area 626. Thus, the moving person 606 may be prevented from being registered as a background even if its motion stops momentarily.

Accordingly, the image processing apparatus 100 can extract foreground data precisely.

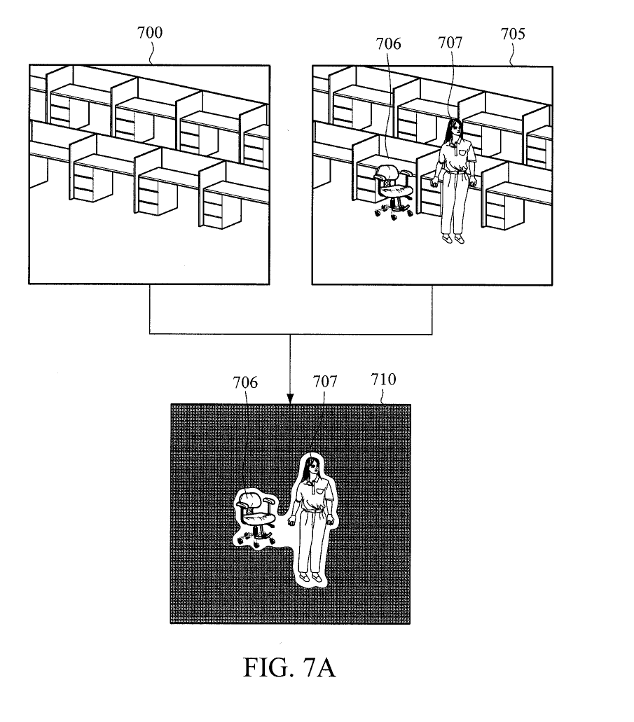

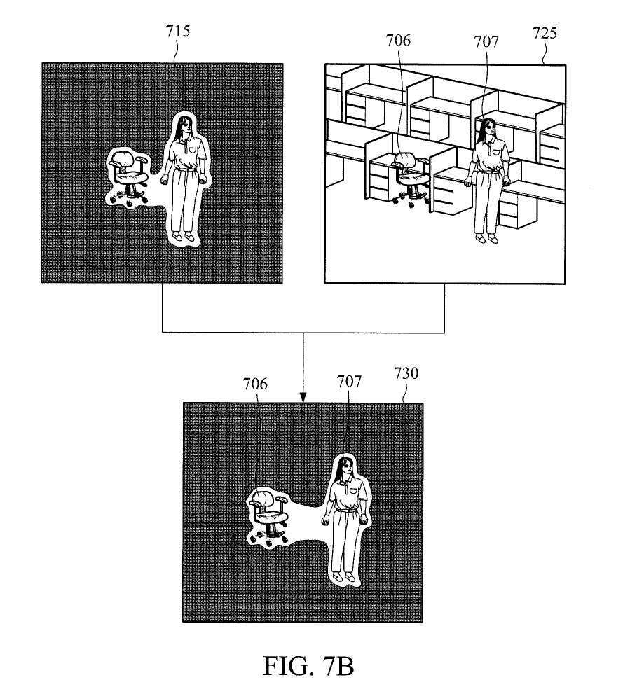

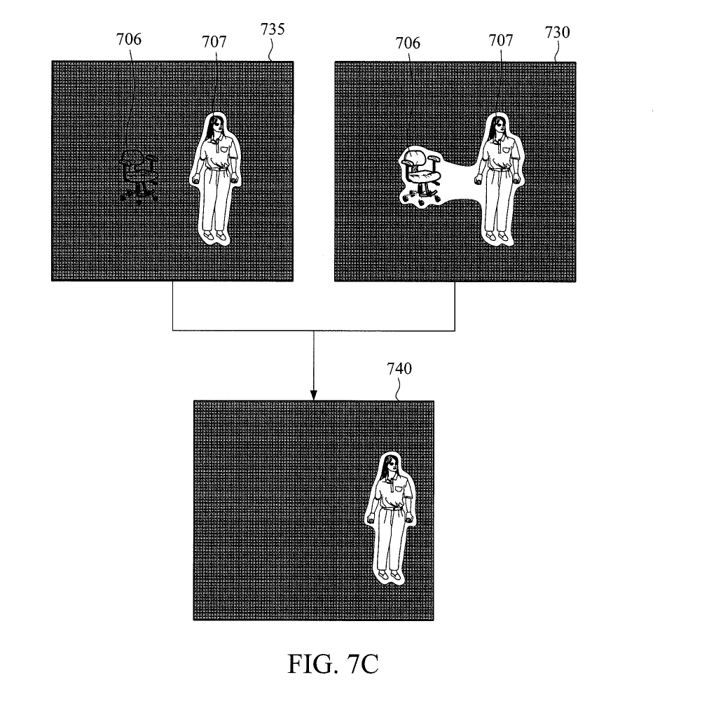

FIGS. 7A, 7B and 7C illustrate exemplary images for explaining a procedure in which another example of an image processing method is performed.

FIG. 7A illustrate images for explaining a process in which the foreground generator 103 (see FIG. 1) compares short-term background data 700 with second image data 705 to generate first foreground data. Referring to FIG. 7A, the background generator 102 generates the short-term background data 700 based on received image data (referred to as first image data) and then compares the short-term background data 700 with the second image data 705. The second image data 705 may include a chair image 706 and a person image 707. The foreground generator 103 compares the short-term background data 700 with the current image data (second image data) 705 to generate the first foreground data. The foreground generator 103 compares a first distance for the short-term background data 700 with a second distance for the current image data (second image data) (705) to generate second foreground data. Then, the foreground generator 103 generates third foreground data 710 that is commonly included in the first and second foreground data. The third foreground data 710 includes the chair image 706 and the person image 707.

Referring to FIG. 7B, the background generator 102 updates an area 715 excluding the chair image 706 and the person image 707, as short-term background data. Then, after a predetermined time elapses, the foreground generator 103 compares the short-term background data with currently received image data (referred to as third image data) 725 to generate third foreground data 730. It can be seen from the third foreground data 730 that the chair image 706 is maintained as it is and the person image 707 is moved.

Referring to FIG. 7C, the foreground generator 103 generates long-term background data 735 based on the current image data (that is, the third image data) 725. The long-term background data 735 corresponds to an area of the third image data 725 that is maintained without any data variations during a time period longer than a predetermined long-term reference time. The long-term background data 735 includes the chair image 706. The foreground generator 103 compares the long-term background data 735 with the third foreground data 730 to generate fourth foreground data 740.

Accordingly, by comparing the long-term background data 735 with the third foreground data 730, motionless areas among areas determined to belong to the third foreground data can be prevented from being extracted as foreground data.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image processing apparatus, comprising:
a background generator to generate background data from first image data composed of one or more image frames, using information regarding durations for which background areas of the first image data are generated where data variations between the image frames are below a predetermined threshold value;
a distance calculator to calculate first distances from an image acquiring unit for acquiring the image frames to objects included in the background data and second distances from the image acquiring unit to objects included in second image data received by the image acquiring unit after a predetermined time elapses; and
a foreground generator to generate first foreground data based on the background data and the second image data, to generate second foreground data based on the first distances and the second distances, and to generate third foreground data based on the first foreground data and the second foreground data.

2. The image processing apparatus of claim 1, wherein the foreground generator compares the first distances with the second distances, to generate image data from the second image data as the second foreground data, corresponding to objects that are determined to be positioned nearer to the image acquiring unit than objects corresponding to the background data.

3. The image processing apparatus of claim 1, wherein the foreground generator generates, as the third foreground data, image data which denotes areas in which an area corresponding to the first foreground data overlaps an area corresponding to the second foreground data.

4. The image processing apparatus of claim 1, wherein the background generator generates the background data which denotes the background areas of the first image data, when the durations of the background areas are equal to or longer than a predetermined threshold value.

5. The image processing apparatus of claim 1, wherein the background areas are processed in units of pixels or in units of blocks.

6. The image processing apparatus of claim 1, wherein the foreground generator compares the background data with the second image data in units of blocks using Normalized Cross Correlation (NCC).

7. An image processing apparatus, comprising:
a background generator to generate short-term background data from first image data composed of one or more first image frames, using information regarding durations for which first background areas of the first image data are generated where data variations between the first image frames are below a first threshold value, and to generate long-term background data from second image data composed of one or more second image frames received after a predetermined time elapses, using information regarding durations for which second background areas of the second image data are generated where data variations between the second image frames are below a second threshold value;
a distance calculator to calculate first distances from an image acquiring unit to objects included in the short-term background data and second distances from the image acquiring unit to objects included in the second image data; and
a foreground generator to generate first foreground data based on the short-term background data and the second image data, to generate second foreground data based on the first distances and the second distances, to generate third foreground data based on the first foreground data and the second foreground data and to generate fourth foreground data by comparing the third foreground data with the long-term background data.

8. The image processing apparatus of claim 7, wherein the foreground generator compares the first distances with the second distances, to generate, as the second foreground data, image data from the second image data, the image data denoting objects that are determined to be positioned nearer to the image acquiring unit than objects corresponding to the short-term background data.

9. The image processing apparatus of claim 7, wherein the background generator generates the first background areas as the short-term background data when the durations of the first background areas are equal to or longer than the first threshold value, and generates the second background areas as the long-term background data when the durations of the second background areas are equal to or longer than the second threshold value.

10. The image processing apparatus of claim 7, wherein the foreground generator generates, as the third foreground data, image data which denotes areas in which areas corresponding to the first foreground data overlap areas corresponding to the second foreground data.

11. The image processing apparatus of claim 7, wherein the foreground generator compares the short-term background data with the second image data or the third foreground data with the long-term background data, in units of blocks, using Normalized Cross Correlation (NCC).

12. An image processing method, comprising:
generating short-term background data from first image data composed of one or more first image frames, using information regarding durations for which first background areas of the first image data are generated where data variations between the first image frames are below a first threshold value;
calculating first distances from an image acquiring unit for acquiring the image frames to objects included in the short-term background data and second distances from the image acquiring unit to objects included in the second image data; and
comparing the short-term background data with the second image data to generate first foreground data;
comparing the first distances with the second distances to generate second foreground data; and
generating third foreground data based on the first foreground data and the second foreground data.

13. The image processing method of claim 12, further comprising:
generating long-term background data from second image data composed of one or more second image frames received after a predetermined time elapses, using information regarding durations for which second background areas of the second image data are generated where data variations between the second image frames are below a second threshold value; and
comparing the long-term background data with the third foreground data to generate fourth foreground data.

14. The image processing method of claim 12, wherein the generating of the second foreground data comprises comparing the first distances with the second distances to generate, as the second foreground data, image data from the second image data, the image data denoting objects that are determined to be positioned nearer to the image acquiring unit than objects corresponding to the short-term background data.

15. The image processing method of claim 13, wherein the generating of the short-term background data comprises generating the first background areas as the short-term background data when the durations of the first background areas are equal to or longer than the first threshold value, and the generating of the long-term background data comprises generating the second background areas as the long-term background data when the durations of the second background areas are equal to or longer than the second threshold value.

16. The image processing method of claim 12, wherein the comparing of the short-term background data with the second image data to generate the first foreground data comprises the short-term background data with the second image data in units of blocks using Normalized Cross Correlation (NCC).

17. The image processing method of claim 13, wherein the comparing of the long-term background data with the third foreground data to generate the fourth foreground data comprises comparing the long-term background data with the third foreground data in units of blocks using Normalized Cross Correlation (NCC).

18. The image processing method of claim 12, further comprising updating the short-term background data based on the third foreground data.

19. The image processing method of claim 12, wherein the first and second background areas are processed in units of pixels or in units of blocks.

20-23. (canceled)
